(19) United States
(12) Patent Application Publication
(10) Pub. No.: US 2009/0173507 A1
(43) Pub. Date: Jul. 9, 2009

(54) SYSTEM AND METHOD FOR REMOVING SMOKE AND HEAT FROM A STRUCTURE

(76) Inventor: Thomas Foley, Joliet, IL (US)

Correspondence Address: MCANDREWS HELD & MALLOY, LTD, 500 WEST MADISON STREET, SUITE 3400, CHICAGO, IL, 60661, US

(21) Appl. No.: 11/969,099

(22) Filed: Jan. 3, 2008

(51) Int. Cl. A62C 39/00

(52) U.S. Cl. 169/91

(57) ABSTRACT

Certain embodiments of the present invention provide a ventilator system and method for transferring heat and smoke from within a structure to outside the structure during a fire. The ventilator may include a housing being configured to receive heat and smoke through an intake port and expel heat and smoke through and exhaust port. The housing may have a channel between the intake port and the exhaust port wherein a motor creates airflow from the direction of the intake port to the exhaust port. The ventilator may also include an extension member having a first end and a second end. The first end may be connected to the intake port of the housing and the second end is configured for insertion into the structure.

### BACKGROUND OF THE INVENTION

The present invention generally relates to a system for ventilating a space from undesirable conditions. More specifically, the present invention relates to a system for ventilating a space by improved removal of smoke during a fire.

A fire in a structure generates smoke and heat. Typically, smoke and heat quickly fill the structure, creating a hazard to the structure's occupants and firefighters working to put the fire out. Firefighters have several techniques to combat the smoke and heat generated by a fire. In one technique, the firefighters may cut a hole in the roof. The hole in the roof may allow heat and smoke to escape the structure. Allowing smoke and heat to escape may minimize heat and smoke damage to the structure and also decreases the level of danger to the structure's occupants and firefighters.

Often, however, valuable time may be lost during a fire because it generally takes several minutes for a firefighter to cut a hole in the roof. The use of hand tools, such as an axe, often requires an even longer period of time to create the hole. During the time that it takes to cut a hole in the roof, the smoke may have little or no place to escape thus causing further damage to the structure and additional danger to occupants and firefighters. Even when the hole is cut into the roof, the rate of escape of smoke and heat may depend on the location of the hole, and the air flow in and around the structure. Therefore, a need exists to better ventilate a structure during a fire.

### BRIEF SUMMARY OF THE INVENTION

Certain embodiments of the present invention provide a ventilator for transferring heat and smoke from within a structure to outside the structure. The ventilator includes a housing being configured to receive heat and smoke through an intake port and expel heat and smoke through and exhaust port. The housing has a channel between the intake port and the exhaust port wherein a motor creates airflow from the direction of the intake port to the exhaust port. The ventilator also includes an extension member having a first end and a second end. The first end is connected to the intake port of the housing and the second end is configured for insertion into the structure. In an embodiment, the extension member is a cylindrical intake pipe. In another embodiment, the extension member is a flexible hose. In an embodiment, the second end of the extension member is configured for piercing the structure. The ventilator may also include a roof catch plate for inhibiting the movement of the ventilator through the insertion into the structure. In an embodiment, the motor is an electric motor. The ventilator may also include a power cord. The power cord may be configured to provide electric power to the electric motor. The power cord may be connected to a power source external to the ventilator. The power source external to the ventilator may be a battery pack. The power source external to the ventilator is a vehicle. The vehicle may be a fire engine.

Certain embodiments of the present invention may also include a method for transferring heat and smoke from within a structure to outside the structure. The method may include identifying a location for insertion of an extension member. The method may also include inserting the extension member into the structure. The method may also include activating the ventilation device to extract the smoke and heat from the structure. In an embodiment, the location for insertion of an extension member is a roof vent. In an embodiment, the location for insertion of an extension member is a window. In an embodiment, the location for insertion of an extension member is a skylight. In an embodiment the location for insertion of an extension member is the side of a mobile home. In an embodiment, the step of inserting the extension member into the structure includes piercing the exterior of the structure.

Certain embodiments of the present invention may also include a system for transferring heat and smoke from within a structure to outside the structure. The system may include a ventilation device configured to receive heat and smoke through an intake port and expel heat and smoke through an exhaust port. The ventilation device having a motor the motor having a fan to create airflow through the intake port and the exhaust port. The system may also include an extension member having a first end and a second end, wherein the first end is connected to the intake port of the housing and the second end is configured for insertion into the structure. The motor may be gas powered, electric powered, or hydraulically powered.

### BRIEF DESCRIPTION OF THE DRAWINGS

FIG. 1 illustrates a device for smoke and heat ventilation in accordance with an embodiment of the present invention.

FIG. 2 illustrates a method for ventilating smoke and heat during a fire in accordance with an embodiment of the present invention.

FIG. 3 illustrates a device for smoke and heat ventilation shown in an auxiliary view in accordance with an embodiment of the present invention.

### DETAILED DESCRIPTION OF THE INVENTION

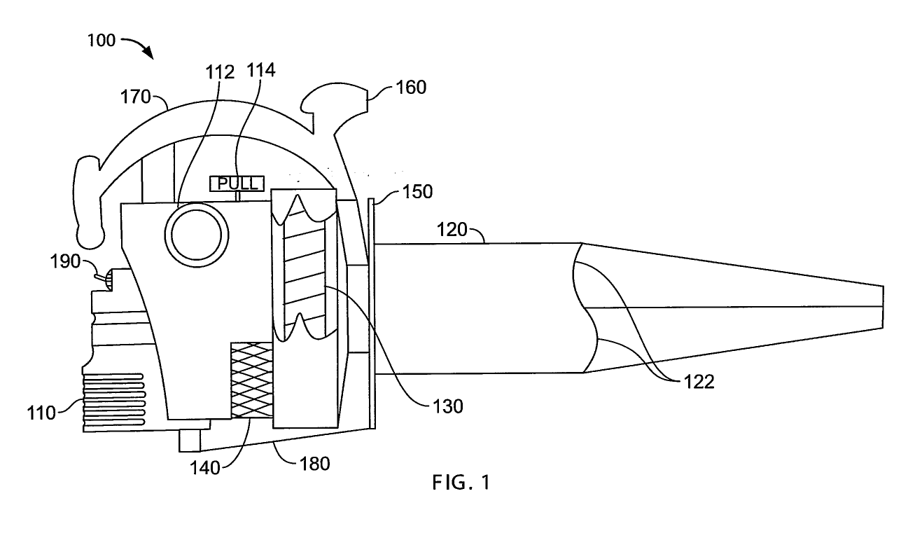

FIG. 1 illustrates a device for smoke and heat ventilation in accordance with an embodiment of the present invention. The ventilator 100 includes a motor 110, a fuel cap 112, a pull rope 114, an intake pipe 120, a smoke intake portion 122, an intake fan 130, an exhaust port 140, a roof catch plate 150, a roof stabilizer 160, a carrying handle 170, a stabilizing bar 180, and an on/off switch 190.

In an embodiment, the ventilator 100 contains a gasoline powered motor 110. FIG. 1 illustrates a gasoline powered ventilator 100. Fuel cap 112 indicates where fuel is added to the ventilator 100. The fuel cap 112 may be brightly colored and clearly marked to indicate the type of fuel that the ventilator 100 requires. Furthermore, pull rope 114 allows a user to start the ventilator 100. In an embodiment, motor 110 can be a standard two stroke gas powered motor. Alternatively, a more powerful or less powerful motor may be used in order to move the desired amount of air.

In an alternative embodiment, the ventilator 100 may contain an electric motor. In an embodiment, the electric motor may be powered by a battery. The battery may be on-board the ventilator 100 or may be separate from the ventilator. For example, the battery may be carried to the location of use as part of a back-pack by the user. In this example, the battery may be connected by a cord to the ventilator 100. In another embodiment, the battery may be carried to the location of use in a case. The case may be connected to the ventilator 100 through a cord. In yet another embodiment, the ventilator 100 may be connected to the battery through a cord, where the battery is located away from the fire, for example on the fire truck. Other types of motors for use on the ventilator 100 are also contemplated.

In an embodiment, the ventilator 100 contains an intake pipe 120. The intake pipe 120 is generally an elongated pipe. The intake pipe 120 is generally a cylindrical shape, having a first end connected to the intake of the motor 110 and a second end for receiving elements, for example smoke and air. The cylindrical shape of the intake pipe 120 generally allows the second end of the intake pipe 120 to be inserted through an opening, for example through an opening in a roof. In an embodiment, the intake pipe 120 is constructed from stainless steel. Stainless steel is a suitable material because it provides a counter weight to the motor, which allows the ventilator 100 to stay securely in place during operation. Also, stainless steel is able to withstand a high temperature. It is contemplated that any material suitable for the conditions of operation may be used.

Connected to the second end of the intake pipe 120 is a tapered smoke intake portion 122 of the intake pipe 120. The tapered smoke intake portion 122 may prevent the ventilator 100 from falling completely within the hole in which it operates. In an embodiment, the tapered smoke intake portion 122 is of a mesh structure. The mesh structure allows smoke and heat to be received into the intake pipe 120, but also prevents burning material from entering the intake pipe 120. In another embodiment, the tapered smoke intake portion 122 is open to allow for maximum air intake. In yet another embodiment, the smoke intake portion 122 may be used as a piercing device. In an embodiment, the smoke intake portion 122 may be structured into two flat pieces of steel arranged in an “X” shape that taper downward. The “X” shape may allow piercing of windows, skylights, roof vents, or other structural element suitable for piercing.

In an alternative embodiment, the ventilator 100 may not utilize an intake pipe 120. The ventilator 100 may connect to a flexible hose that may be inserted into a building, for example through a window or skylight. For example, the ventilator 100 may be a mobile unit positioned away from fire and a flexible hose may be inserted into a building window or skylight. In other embodiments, the ventilator 100 may have attachments designed to fit over a removed attic fan, a removed skylight, or any other similar opening in a roof.

The ventilator 100 may contain an intake fan 130. In operation, the intake fan 130 may be powered to create suction through the intake pipe 120. In an embodiment, the intake fan 130 may create at least 425 cubic feet of air per minute. The intake fan 130 may be constructed of any material suitable for use with high temperatures. In FIG. 1, the intake fan 130 is located behind the intake pipe 120. In an alternative embodiment, the intake fan 130 may be located within the intake pipe 120. In other embodiments where there is no intake pipe, the intake fan 130 may be located near the motor 110. The ventilator 100 may contain an exhaust port 140. The exhaust port 140 provides a location for smoke and heat that have been sucked into the ventilator 100 to exit the ventilator 100.

In an embodiment, the ventilator 100 contains a roof catch plate 150. The roof catch plate 150 may abut the roof or other structure, and stabilizes the ventilator 100 during use. The roof catch plate 150 also provides protection to the motor 110 by shielding it from smoke damage. In an embodiment, the roof catch plate 150 is constructed from stainless steel. Alternatively, it may be constructed from any other suitable material. A roof stabilizer 160 may also be used in conjunction with the roof catch plate 150. The roof stabilizer 150 may aide in securing the ventilator during operation. In an embodiment, the roof stabilizer 160 is placed on the lower side of a sloped roof. The roof stabilizer 160 thus helps to secure the ventilator on a steeply sloped roof. Additionally, in this embodiment, the roof stabilizer is placed opposite to the exhaust port 140. As such, smoke and heat will exit the ventilator 100 on the higher side of a sloped roof, which may help to keep smoke away from the motor 110.

In certain embodiments, the ventilator 100 includes a carrying handle 170. The carrying handle 170 allows a firefighter to easily transport the ventilator 100 to the roof of a structure. The carrying handle 170 may be large enough to allow a firefighter to carry the device 100 while wearing structural firefighting gloves. Alternatively, the carrying handle 170 may allow the device 100 to be lifted onto the roof of a structure with a rope, webbing, a carabineer, or any mechanism that can be used to hoist the device 100 onto the structure.

In an alternative embodiment, the ventilator 100 may contain an additional carrying handle 170. An additional carrying handle 170 may be used to provide enough leverage for a firefighter to a pierce hole in a roof or other structure. As a result, the ventilator 100 can be used on a structure without a preexisting hole and a hole may be made anywhere on the structure.

In certain embodiments, the ventilator 100 includes a stabilizing bar 180. The stabilizing bar 160 provides support while holding the unit, especially when the ventilator 100 is in operation. Additionally, the stabilizing bar 180 provides protection to the unit and can act as a stand when the unit is laid on the ground, in a cabinet, or put in another location while not in use.

In certain embodiments, the ventilator 100 includes an on/off switch 190. In an embodiment, the on/off switch 190 may allow an electric powered motor to be switched on and off. In certain embodiments, the on/off switch 190 may allow the ventilator 100 to be switched off quickly. As such, the on/off switch 190 may be brightly colored so that it can be easily located.

In operation, the ventilator 100 may be used to extract smoke and heat from a burning structure. The intake pipe 120 may be inserted into a structure through an existing hole in the structure, for example a ventilation duct, window, skylight, or other hole. Alternatively, the intake pipe 120 may be used to create a hole in the structure. In another alternative, a flexible hose may be inserted into a window or other hole in the structure. Once the intake pipe 120 is inserted into the structure, the motor of the ventilator 100 may be started. The motor creates suction to remove smoke and heat from the burning structure by creating air flow.

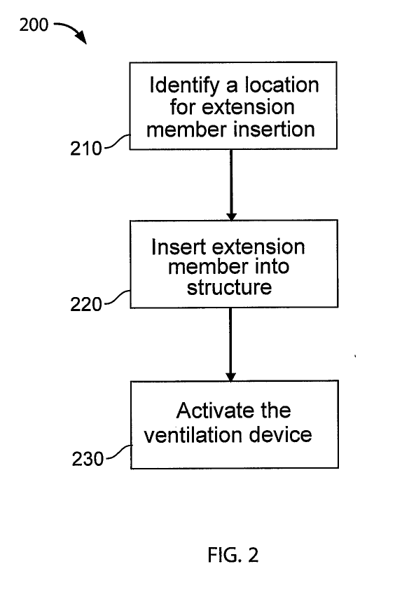

FIG. 2 illustrates a flow diagram for a method 200 for smoke and heat ventilation in accordance with an embodiment of the present invention. At step 210 of the method 200, a location for insertion of an extension member is identified. The location for insertion of an extension member may be an existing hole in the structure, such as a window, ventilation hole, skylight, or other hole. The extension member may be an intake pipe, flexible hose, or other device that can be inserted into the structure. In an embodiment, the existing hole may be covered by a metal roof vent. In this embodiment, a firefighter may remove the vent cover to reveal the hole in the roof. For instance, the firefighter may kick the vent cover off to access the hole. At step 220, the extension member is inserted into the structure. The extension member may be inserted, for example, by dropping through a hole in the roof of the structure. In another embodiment, when the extension member is flexible, the extension member may be tossed through an open window in the structure. In another embodiment, the extension member may be used to create a hole in the structure, and then the extension member may be inserted in the structure. For example, the ventilator 100 may be used to pierce the roof, thereby creating a hole in the roof, as described above with regard to FIG. 1. In yet another embodiment, the ventilator 100 may be used to pierce a hole in the side of a structure, such as a mobile home. At step 230, the ventilating device is activated. For example, in an embodiment, the motor may be activated and ventilation may be engaged. In an embodiment, pulling the pull rope starts a gas-powered motor. In an alternative embodiment, an electric or battery powered ventilator may be powered on by toggling the on/off switch. In yet another embodiment, a hydraulically powered ventilator may be powered by running water through the device.

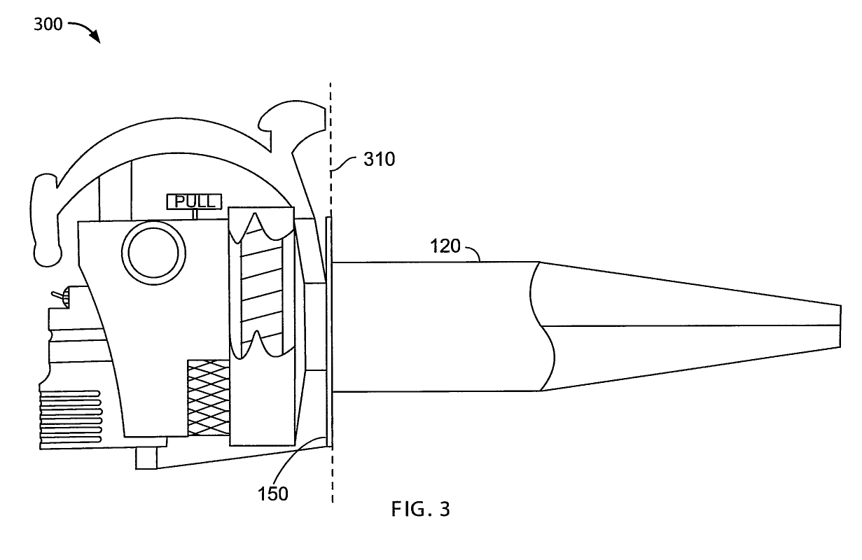

FIG. 3 illustrates auxiliary view 300 of the device for smoke and heat ventilation in accordance with an embodiment of the present invention as shown in FIG. 1. In the auxiliary view 300, the device is in position to operate in accordance with an embodiment of the present invention. The ventilator 100 may be placed within a hole on the roof of a burning structure. In FIG. 3 the intake pipe 120 is shown within the hole below the roof line 310. FIG. 3 also shows the roof catch plate 150. The roof catch plate restricts the movement of the ventilator 100 and supports the ventilator against entering the structure through the hole.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A ventilator for transferring heat and smoke from within a structure to outside the structure, said ventilator comprising:
a housing being configured to receive heat and smoke through an intake port and expel heat and smoke through and exhaust port, said housing having a channel between said intake port and said exhaust port wherein a motor creates airflow from the direction of the intake port to the exhaust port;
an extension member having a first end and a second end, wherein said first end is connected to the intake port of said housing and said second end is configured for insertion into said structure.

2. The ventilator of claim 1, further comprising a roof catch plate for inhibiting the movement of said ventilator through said insertion into said structure.

3. The ventilator of claim 1, wherein said extension member is a cylindrical intake pipe.

4. The ventilator of claim 1, wherein said extension member is a flexible hose.

5. The ventilator of claim 1, wherein said second end of said extension member is configured for piercing said structure.

6. The ventilator of claim 1, wherein said motor is an electric motor.

7. The ventilator of claim 6, further comprising a power cord, said power cord configured to provide electric power to said electric motor, wherein said power cord is connected to a power source external to said ventilator.

8. The ventilator of claim 7, wherein said power source external to said ventilator is a battery pack.

9. The ventilator of claim 7, wherein said power source external to said ventilator is a vehicle.

10. The ventilator of claim 9, wherein said vehicle is a fire engine.

11. A method for transferring heat and smoke from within a structure to outside the structure, said method comprising:
identifying a location for insertion of an extension member;
inserting said extension member into said structure; and,
activating said ventilation device to extract said smoke and heat from said structure.

12. The method of claim 11, wherein said location for insertion of an extension member is a roof vent.

13. The method of claim 11, wherein said location for insertion of an extension member is a window.

14. The method of claim 11, wherein said location for insertion of an extension member is a skylight.

15. The method of claim 11, wherein said location for insertion of an extension member is the side of a mobile home.

16. The method of claim 11, wherein said step of inserting said extension member into said structure includes piercing the exterior of said structure.

17. A system for transferring heat and smoke from within a structure to outside the structure, said system comprising:
a ventilation device configured to receive heat and smoke through an intake port and expel heat and smoke through and exhaust port, said ventilation device having a motor, said motor having a fan to create airflow through said intake port and said exhaust port; and,
an extension member having a first end and a second end, wherein said first end is connected to the intake port of said housing and said second end is configured for insertion into said structure.

18. The system of claim 17, wherein said motor is a gas powered motor.

19. The system of claim 17, wherein said motor is an electric powered motor.

20. The system of claim 17, wherein said motor is hydraulically powered.
